(19) United States
(12) Patent Application Publication
(10) Pub. No.: US 2012/0260106 A1
(43) Pub. Date: Oct. 11, 2012

(54) SYSTEM AND METHOD FOR BINARY LAYOUT RANDOMIZATION

(75) Inventors: Ganna Zaks, Mountain View, CA (US); Julien Lerouge, Santa Clara, CA (US); Jon McLachlan, San Francisco, CA (US); Gideon M. Myles, San Jose, CA (US); Augustin J. Farrugia, Cupertino, CA (US)

(73) Assignee: Apple Inc., Cupertino, CA (US)

(21) Appl. No.: 13/081,994

(22) Filed: Apr. 7, 2011

(51) Int. Cl. G06F 12/14

(52) U.S. Cl. 713/190; 726/26

(57) ABSTRACT

Disclosed herein are systems, methods, and non-transitory computer-readable storage media for binary layout randomization. A system performs binary layout randomization by loading computer code into memory and identifying a section of the computer code to randomize. A loader remaps the section of computer code to a different location in memory utilizing a remapping algorithm. The loader can shuffle sections of code in place or move sections of code elsewhere. The loader patches relative addresses to point to the updated locations in memory. After the system patches the addresses, the system executes the computer code from memory. In one embodiment, the system encrypts the computer code prior to loading the computer code into memory. The loader decrypts the encrypted computer code prior to remapping the section of computer code to a different location in memory. Optionally, the loader can decrypt the encrypted computer code after patching relative addresses.

### BACKGROUND

1. Technical Field

The present disclosure relates to code obfuscation and more specifically to binary layout randomization.

2. Introduction

Security is an integral part of many computing systems today. Securing computing systems from potential attackers and reverse engineers is a challenging and dynamic task. Attackers use a variety of static and/or dynamic reverse engineering techniques to attack computing systems. These attacks can be launched at varying stages in the development of software, such as stealing source code or modifying binary code such that its semantics are different from what was originally intended. Examples of modifying binary code include inserting additional operations, collecting user data such as user passwords, bypassing security features, and inserting malicious code into existing program code.

An attacker can use a number of different reverse engineering tools to determine the point in a program to insert malicious code. Often the locations are simply constant offsets into the original binary. When the program is executed, the attacker calls a script which inserts calls to his own routines at the given offsets in the binary, thereby redirecting to the adversary's code. This attack is easily distributed to other users that are running the same program with no modification. Attacks such as this can produce malicious results and are potentially harmful to a computing system, the user, and/or the Internet, for instance when an attacker inserts code to spread a computer virus, inserts code to steal personal information, or joins the computing system to a network of compromised machines (i.e. a botnet).

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for binary layout randomization. A system practicing the method performs binary layout randomization by loading computer code into memory and identifying a section of the computer code to randomize. A layout randomizing loader remaps the section of computer code to a different location in memory based on a remapping algorithm. The remapping algorithm can produce a different mapping or layout at each execution of a binary, for example. The loader can shuffle sections of code in place or move sections of code elsewhere. The loader patches relative addresses to point to the different location in memory. After the system patches the addresses, the system executes the computer code from memory.

In one embodiment, the system encrypts the computer code at compile time, prior to loading the computer code into memory. The loader decrypts the encrypted computer code prior to remapping the section of computer code to a different location in memory. Alternately, the loader can decrypt the encrypted computer code after patching relative addresses or after shuffling encrypted blocks. Decrypting computer code after patching relative addresses can provide an additional level of security for a computing system, because the code spends less time in plaintext before execution begins, but more so it is almost impossible to follow the modification of an encrypted binary.

Performing binary layout randomization increases the difficulty for an attacker to distribute an effective and widespread attack in the form of a script that modifies a binary because the layout of the binary changes dynamically each time the system loads the binary into memory.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example virtual memory configuration;

FIG. 3 illustrates an exemplary binary layout randomization method embodiment;

FIG. 4 illustrates a first example binary layout system embodiment;

FIG. 5 illustrates a second example binary layout system embodiment;

FIG. 6 illustrates a first example method embodiment for binary layout randomization utilizing decryption; and

FIG. 7 illustrates a second example method embodiment for binary layout randomization utilizing decryption.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

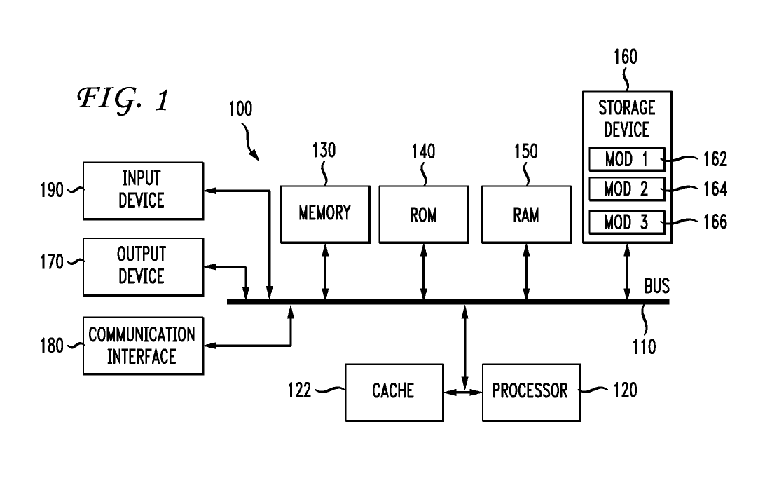

The principles of the present disclosure can thwart attempts by attackers to modify computer code to introduce any functionality not originally intended. Binary layout randomization increases the difficulty for an attacker to reverse engineer computer code and distribute a widespread attack. A system, method and non-transitory computer-readable media are disclosed which randomize binary layouts. A brief introductory description of a basic general purpose system or computing device in FIG. 1 which can be employed to practice the concepts is disclosed herein. A more detailed description of binary layout randomization will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

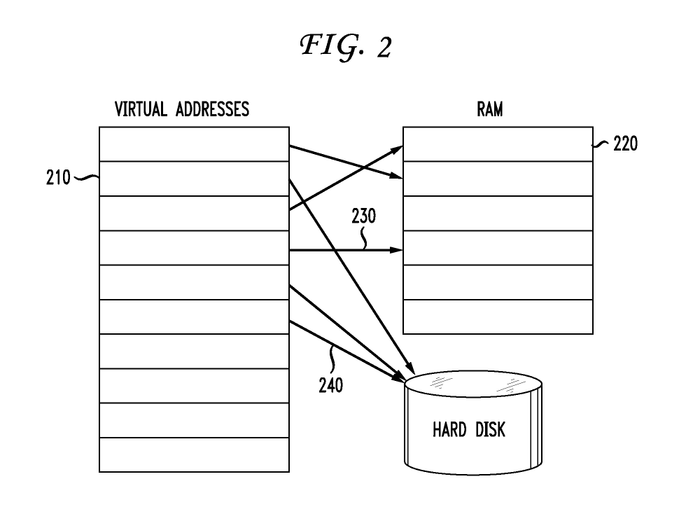

Having disclosed some components of a computing system, the disclosure now turns to FIG. 2, which illustrates virtual memory. In a computing system, the processor accesses programs and data stored in memory using a memory address. Different types of physical memory components exist such as CPU registers, cache and random access memory (RAM). Virtual memory utilizes storage devices, such as solid state drives or hard drives, to emulate additional memory beyond that which is physically available in the computing system. The virtual memory approach can be applied when the amount of RAM installed in a computer is insufficient to handle all requests for memory at a particular time. Utilizing virtual memory can allow a user to run multiple programs at once that would require more memory than the computer has, for example.

Virtual memory is typically divided into pages. A page is a block of contiguous virtual memory addresses. A page table can translate a virtual address 210 into a physical address in RAM 220 used by the hardware. Entries in the page table map a virtual page to another page table, the physical memory address of the page 230 or an indication that the page is held in disk 240. Binary layout randomization can utilize RAM and/or virtual memory to protect binary code by remapping sections of computer code to different locations in RAM or virtual memory to prevent or hinder an attacker from gaining unauthorized access to computer code or to prevent an attacker from relying on a specific section of the code being loaded at a specific address.

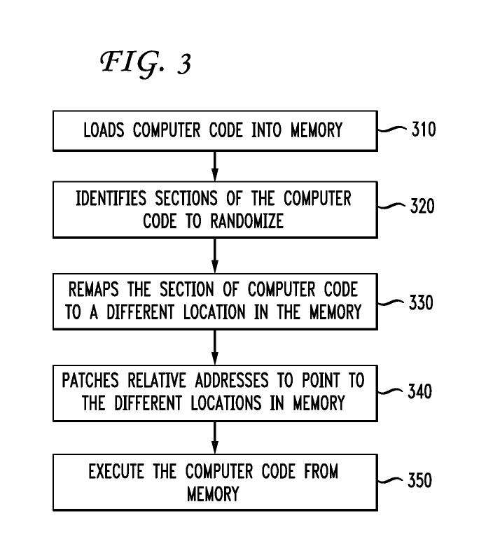

Having disclosed some basic system components and concepts, the disclosure now turns to the exemplary method embodiment for performing binary layout randomization shown in FIG. 3. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

The system 100 loads computer code into memory (310). Computer code can include binary code or any other code executable by a computer. A binary file can be a computer file containing data encoded in binary form. A binary file can contain any type of data, including text, images, compressed files and compiled computer programs. The system 100 can perform binary layout randomization on a binary file or computer code containing any type of data, but is primarily discussed herein with respect to an executable binary file.

The system 100 identifies a section of the computer code to randomize (320). The system can identify a single section or multiple sections of the computer code to randomize. However, these same principles apply equally to other types of data that is not writable, such as constant data. A section can be a page of memory, less than a page, more than a page or an entire text section of a binary file, for example. The system can identify a section of code to randomize randomly or based on a deterministic process. The system can identify code based on number of times the code is accessed, proximity to other sections of code, or any other criteria. Additionally, the system can identify sections of code to randomize based on ease of implementation or performance characteristics.

Once the system identifies a section to randomize, a layout randomizing loader remaps the section to a different location in memory (330) optionally based on a remapping algorithm. The loader can be part of the computer code or can be separate. Many remapping algorithms exist including remapping randomly utilizing an algorithm such as the Knuth shuffle or any other suitable algorithm.

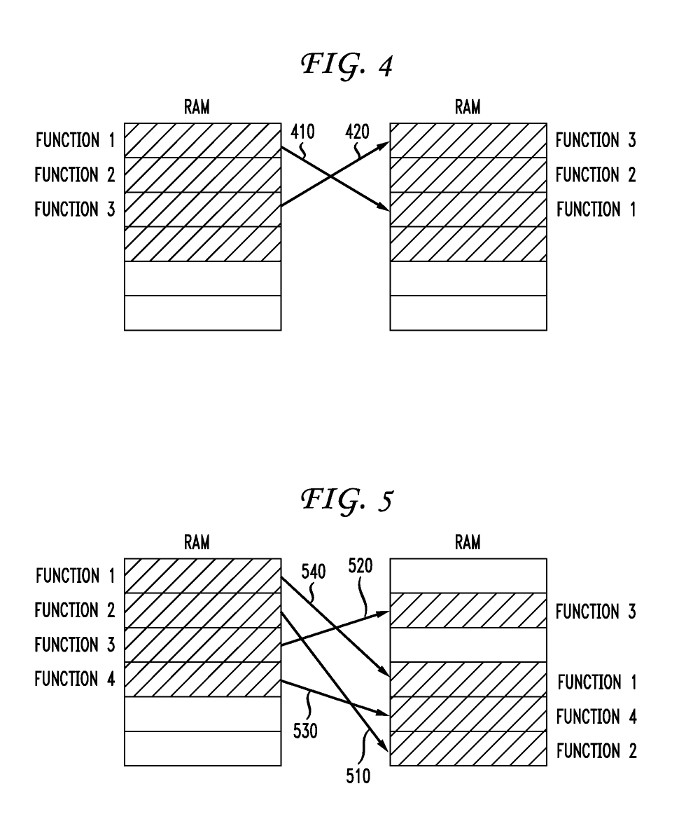

The loader can shuffle the memory sections in place, such as swapping the locations of two memory sections. The memory sections can be pages or any other section of memory. Typically, the system 100 loads a binary into memory pages using contiguous addresses as shown in FIG. 4. For example, three functions namely function 1, function 2 and function 3 are loaded into contiguous memory pages. Function 2 follows function 1, and function 3 follows function 2 in memory. When a system uses binary layout randomization, the loader can randomize the layout of memory pages to complicate attempted attacks by obfuscating the functions' locations in memory. The loader can switch the memory pages 410, 420 storing function 1 and function 3 so that function 2 follows function 3 and function 1 follows function 2 in memory. Functions 1 and 3 have been shuffled and are no longer accessed using an expected order of addresses starting with function 1. An attacker expecting function 3 to follow function 2 will instead find function 1.

Alternately, the loader can move pages to noncontiguous locations in RAM or virtual memory. FIG. 5 illustrates moving pages to new locations in memory. For example, the loader can move function 2 to a new location in memory 510 and can move function 3 to the position that function 2 formerly occupied 520. The loader can move function 4 to a new location in memory 530 and can move function 1 to the position that function 4 formerly occupied 540. An attacker expecting function 2 to follow function 1 will find function 4. Dynamically switching the location of the functions each time the system loads a binary produces unexpected, unpredictable, and unreliable results for an attacker. If an attacker develops an attack, such as a script that modifies how the computer code executes, for a binary layout randomized section of code, the attack would only work once, or at best intermittently, because the system dynamically randomizes the binary each time it loads the binary into memory. This would prevent an attacker from distributing a reliable and effective widespread attack.

After the loader remaps code to a different location, the loader patches relative addresses in memory to point to the different location in memory (340). For example, function main in a computer program calls function 3 which the loader moved to a different location. The loader can update the main function to reflect the new location of function 3. If the loader does not update the new location of function 3 within function main or wherever references to function 3 exist, the system may produce unexpected results and will not perform as intended. Additionally, the loader can patch addresses by utilizing precomputed addresses stored in a map generated at compile time. This approach can be used to reduce or minimize the loading and preparation time required to execute the computer code. The loader can patch addresses based on address adjustments selected at run time. Once the loader patches relative addresses in memory to point to the different location, the system can execute the computer code from memory (350).

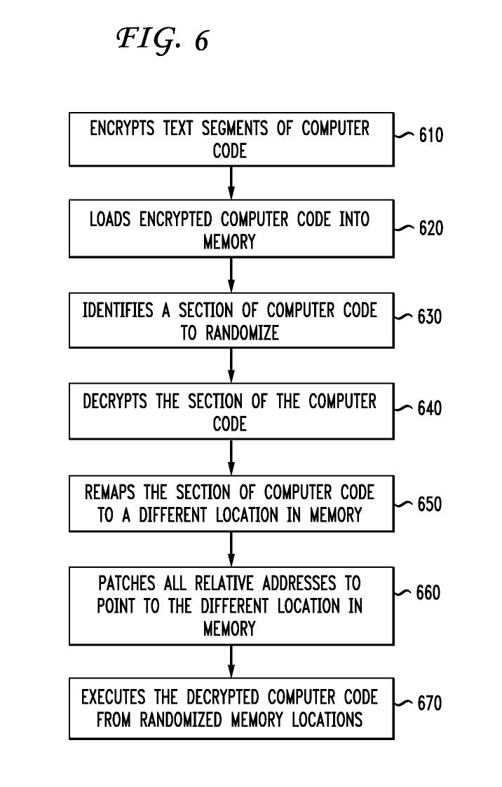

In one embodiment, the system encrypts the text segment of binary code prior to loading the computer code into memory. FIG. 6 illustrates binary layout randomization using encryption. The system 100 encrypts the text segment of computer code (610) using any encryption algorithm such as block ciphers advanced encryption standard (AES) or the stream cipher RC4. While FIG. 6 discloses an approach that includes encrypting the computer code, this approach can optionally replace that step with receiving computer code that is previously at least partially encrypted by another entity. The system loads the encrypted computer code into memory (620). The system identifies a section of the computer code to randomize (630), such as based on flags in the computer code. A component embedded in the computer code and/or a separate component external to the computer code can identify the section to randomize. A section of computer code can be a page of memory, more than a page, less than a page or the entire text section of a binary file. The system can select the section of code randomly, based on an algorithm, or based on a deterministic process. The system decrypts the section of the computer code (640) and remaps the decrypted section of computer code to a different location in memory (650). The system patches the relative addresses to point to the different location in memory (660). Then the system can execute the decrypted computer code from the memory (670).

When the layout randomization is a separate component from the computer code, the operating system or other entity makes a request to execute the computer code through a layout randomization module. The layout randomization module can identify the section, load the computer code, decrypt the code, randomize the layout, and/or perform other steps to prepare and patch the computer code according to the request. The steps of decrypting the code and randomizing the layout can occur in either order, decrypting then randomizing or randomizing then decrypting. Then, when the binary is prepared, the layout randomization module can send a signal to the operating system or other requester that the patched computer code is ready to execute.

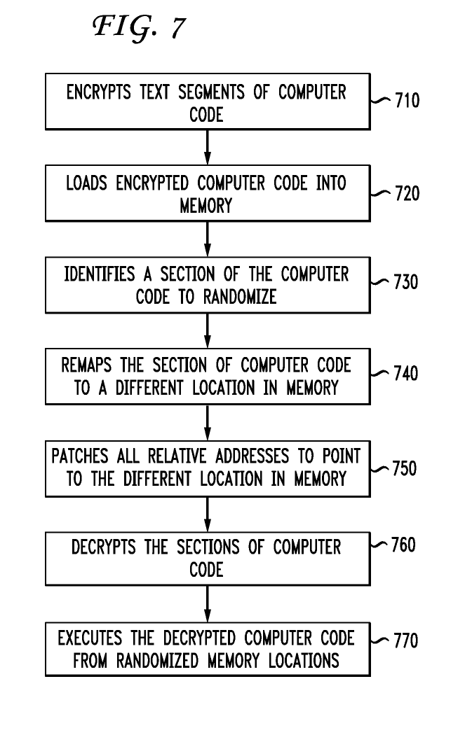

In another embodiment, the system decrypts the section of encrypted computer code after patching relative addresses to point to the different location in memory. FIG. 7 differs from FIG. 6 such that the system 100 performs the decryption process after the remapping and patching processes in contrast to performing the decryption process prior to the remapping and patching processes. FIG. 7 illustrates binary randomization using encryption. The system encrypts the text segment of computer code (710). While FIG. 7 discloses an approach that includes encrypting the computer code, this approach can optionally replace that step with receiving computer code that is previously at least partially encrypted by another entity. The encrypting system and the system running the encrypted computer code may be the same device or two separate devices. The system loads the encrypted computer code into memory (720) and identifies a section of the computer code to randomize (730). The system remaps the encrypted computer code to a different location in memory (740). Then the system patches relative addresses in memory to point to the different location in memory (750). The system can patch before or after decryption. However, patching after decryption may provide performance benefits and may be easier to implement. Once the pages are remapped and addresses patched, the system decrypts the computer code (760). The system can then execute the decrypted computer code from the memory (770). The system can remap and patch the computer code prior to executing the computer code.

Decrypting computer code after the patching process can increase the security of computer code because when the system patches something in the original plaintext of an encrypted block of code, the system must replace the entire block and it is impossible to tell what changed without the original plaintext. Utilizing encryption in binary layout randomization makes reverse engineering attempts and development of other viable, reproducible attacks more difficult. The attacker can attempt to reverse engineer the binary code, but this task is much more cumbersome and time-consuming than if the code were not encrypted, and these heightened efforts can outweigh the potential benefit the attacker expects to receive from the reverse engineering. Any method to slow down an attacker is beneficial in protecting a computing system.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method for executing computer code, the method comprising:
loading computer code into memory;
identifying a section of the computer code;
remapping the section of the computer code to a different location in the memory;
patching, in the computer code, a relative address to the section of the computer code to point to the different location in the memory; and
executing the computer code from the memory.

2. The method of claim 1, wherein identifying, remapping, and patching occur prior to executing the computer code.

3. The method of claim 1, wherein a layout randomizing loader remaps the section of the computer code and patches the relative address.

4. The method of claim 3, wherein the layout randomizing loader is part of the computer code.

5. The method of claim 3, wherein the layout randomizing loader is separate from the computer code.

6. The method of claim 1, wherein the section of the computer code is a page.

7. A system for executing a binary application, the system comprising:
a processor;
a memory;
a first module configured to control the processor to retrieve the binary application and store the binary application in a first location in the memory;
a layout randomizing loader configured to control the processor to remap a page of the binary application in the memory to a second location in the memory;
a patcher module configured to control the processor to identify, in the binary application, relative addresses to the page and patch the relative addresses to point to the second location in the memory; and
a second module configured to control the processor to execute the binary application in the memory.

8. The system of claim 7, wherein the second location is in virtual memory.

9. The system of claim 7, wherein the layout randomizing loader is further configured to control the processor to remap the section of the computer code dynamically such that the second location is different at each consecutive execution of the binary application.

10. The system of claim 7, wherein the second location in the memory is selected randomly.

11. The system of claim 10, wherein the second location is non-contiguous in the memory with respect to remaining pages of the binary application.

12. A non-transitory computer-readable storage medium storing instructions for a computing device to randomize a layout of a binary, the instructions comprising:
identifying that the binary has been loaded into memory to yield a loaded binary;
extracting a portion from the loaded binary;
inserting the portion at a randomly selected location in virtual memory;
processing a remaining portion of the loaded binary to identify relative addresses to the portion; and
patching the relative addresses to point to the randomly selected location to yield a patched binary.

13. The non-transitory computer-readable storage medium of claim 12, the instructions further comprising:
sending a signal that the patched binary is ready to execute.

14. The non-transitory computer-readable storage medium of claim 12, wherein patching the relative addresses is based on a map computed at compile time.

15. The non-transitory computer-readable storage medium of claim 12, wherein patching the relative addresses is based on an address adjustment selected at run time.

16. The non-transitory computer-readable storage medium of claim 12, wherein the binary includes a text section, and wherein the portion is part of the text section.

17. The non-transitory computer-readable storage medium of claim 16, wherein the text section is encrypted.

18. The non-transitory computer-readable storage medium of claim 17, the instructions further comprising:
decrypting the portion of the binary before inserting the portion at the randomly selected location.

19. A compiler for obfuscating binary code, the compiler comprising:
a processor;
a first module configured to control the processor to receive the binary code;
a second module configured to control the processor to identify relative addresses in the binary code;
a third module configured to control the processor to divide the binary code into sections;
a fourth module configured to control the processor to generate a mapping table of the relative addresses by section; and
a fifth module configured to control the processor to insert a layout randomizing loader in the binary code that, upon execution of the binary code in memory, identifies a section of the binary code, remaps the section to a different location in the memory, and patches at least one relative address in the binary code based on the different location and the mapping table.

20. The compiler of claim 19, wherein the binary code is encrypted.

21. The compiler of claim 20, wherein the layout randomizing loader decrypts the binary code prior to remapping the section.

22. The compiler of claim 19, wherein the different location is in virtual memory.

23. The compiler of claim 19, wherein the different location is selected based on a remapping algorithm.
